(19) United States
(12) Patent Application Publication
(10) Pub. No.: US 2006/0209661 A1
(43) Pub. Date: Sep. 21, 2006

(54) Pre-pit signal detector and optical disc recording/reproducing apparatus

(75) Inventor: Katsuo Yamasaki, Yokohama-Shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/353,176

(22) Filed: Feb. 14, 2006

(30) Foreign Application Priority Data
Feb. 15, 2005 (JP) 2005-038079

(51) Int. Cl. G11B 7/00

(52) U.S. Cl. 369/124.07

(57) ABSTRACT

A pre-pit signal detector has a first binarizing unit which converts RF data obtained by reading out information recorded by irradiating a laser light on an optical disc into first binary data composed of a mark and a space, a specific mark detector which detects a specific mark included in the first binary data, an LPP detecting window generator which generates an LPP detecting window indicating a range of detecting a pre-pit signal arranged adjacent to the specific mark, a second binarizing unit which generates second binary data by whether or not a signal obtained by reading out the pre-pit signal with the laser light excesses a predetermined slice level, and a slice level adjusting unit which adjusts the slice level based on a result detected by the specific mark detector, the LPP detecting window and the second binary data.

### CROSS REFERENCE TO RELATED APPLICATIONS

This application is based upon and claims the benefit of priority from the prior Japanese Patent Application No. 2005-38079, filed on Feb. 15, 2005, the entire contents of which are incorporated herein by reference.

### BACKGROUND OF THE INVENTION 1. Field of the Invention

The present invention relates to a pre-pit signal detector and an optical disc recording/reproducing apparatus capable of detecting a pre-pit signal recorded to an optical disc. 2. Related Art

An recording optical disc as typified by a DVD-R/RW has groove tracks in which data is recorded due to laser power irradiation and land tracks in which data is not recorded due to laser power irradiation, and the groove tracks and the land tracks are formed alternately. In the land tracks, a pre-pit signal (LPP signals) which indicates information such as physical address information and information identifying media is recorded in concavity and convexity shapes.

An Optical disc recording/reproducing apparatus controls irradiation of the laser power while scanning a pickup along the groove tracks, and forms physical state portions having low laser reflectivity (marks) and physical state portions having high laser reflectivity (spaces) to record data. When reproducing data, while the pickup is scanned along the groove tracks by using low power laser, the recording data composed of the marks and the spaces are reproduced by using difference of reflectivity at scanning time, and at the same time, the pre-pit signal recorded to the land tracks is detected, a spike portion of the pre-pit signal is detected, and the pre-pit signal is demodulated to generate pre-pit information (see Japanese Patent Publication Laid-open No. 2000-260025).

The pre-pit signal is detected by the spike portion included in a reflected light of the laser. The pre-pit information detected by the pre-pit signal is used for acquisition of recommended parameters for media recording, movement to an objective physical location, decision of recording start timing and so on. If the groove track adjacent to the pre-pit signal is in non-recording state, the pre-pit signal is easily detected and can be binarized. If data is recorded to the adjacent groove track, the amount of laser reflected light lowers at mark scanning time in the pre-pit position overlapping with the mark position, and amplitude of the spike portion of the pre-pit signals decreases. Therefore, the amplitude of the spike portion of the pre-pit signal fluctuates, and binarization of the spike portion becomes difficult.

### SUMMARY OF THE INVENTION

According to one embodiment of the present invention, a pre-pit signal detector, comprising:

a first binarizing unit which converts RF data obtained by reading out information recorded by irradiating a laser light on an optical disc into first binary data composed of a mark and a space;

a specific mark detector which detects a specific mark included in the first binary data;

an LPP detecting window generator which generates an LPP detecting window indicating a range of detecting a pre-pit signal arranged adjacent to the specific mark;

a second binarizing unit which generates second binary data by whether or not a signal obtained by reading out the pre-pit signal with the laser light excesses a predetermined slice level; and

a slice level adjusting unit which adjusts the slice level based on a result detected by the specific mark detector, the LPP detecting window and the second binary data.

Furthermore, according to one embodiment of the present invention, an optical disc recording/reproducing apparatus, comprising:

an optical pickup which reads out information recorded to an optical disc by irradiating a laser light;

an RF data generator which generates RF data based on an output signal of the optical pickup;

a first binarizing unit which converts the RF data into first binary data composed of a mark and a space;

a pre-pit detector which detects a pre-pit signal based on the first binary data,

wherein the pre-pit detector includes:

a specific mark detector which detects a specific mark included in the first binary data;

an LPP detecting window generator which generates an LPP detecting window indicating a range of detecting a pre-pit signal arranged adjacent to the specific mark;

a second binarizing unit which generates second binary data by whether or not a signal obtained by reading out the pre-pit signal with the laser light excesses a predetermined slice level; and

a slice level adjusting unit which adjusts the slice level based on a result of detecting the specific mark detector, the LPP detecting window and the second binary data.

### BRIEF DESCRIPTION OF THE DRAWINGS

FIG. 1 is a block diagram showing schematic configuration of the optical disc recording/reproducing apparatus according to a first embodiment of the present invention.

FIG. 2 is a block diagram showing an example of internal configuration of the LPP detector 11.

FIG. 3 is a diagram showing one example of a waveform of the spike portion of the LPP signal.

FIG. 4A is the LPP detecting signal in the case where the slice level is high, and FIG. 4B is the LPP detecting signal in the case where the slice level is low.

FIG. 5 is a diagram showing one example of the processing result of the slice level controller 29.

FIG. 6 is a flowchart showing one example of processing operations of the slice level controller 29.

FIG. 7 is a block diagram showing internal configuration of the LPP detector 11 according to the second embodiment.

FIG. 8 is a block diagram showing internal configuration of the LPP detector 11 according to a third embodiment.

### DETAILED DESCRIPTION OF THE INVENTION

Hereafter, a receiver and a receiving method according to the present invention will be described more specifically with reference to the drawings.

(First Embodiment)

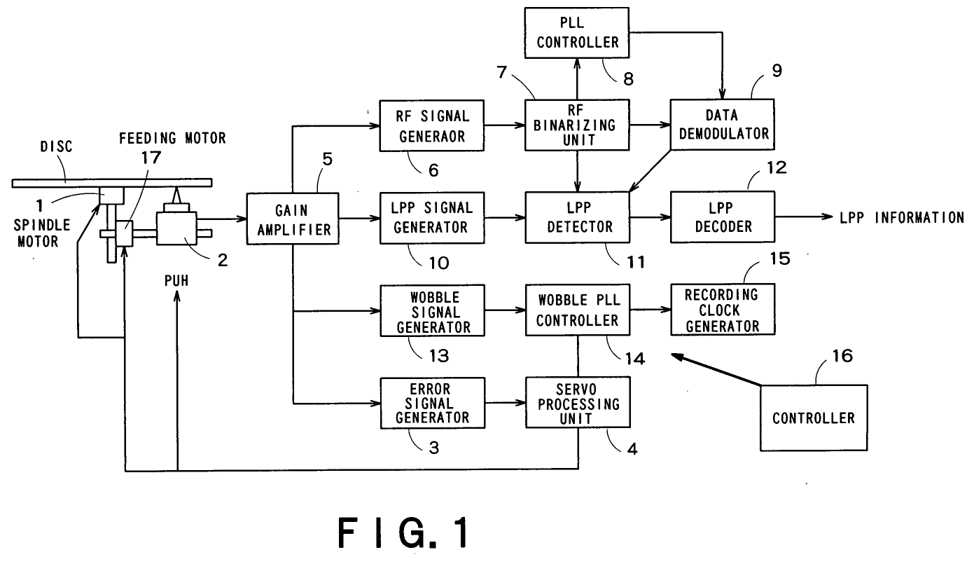

FIG. 1 is a block diagram showing schematic configuration of the optical disc recording/reproducing apparatus according to a first embodiment of the present invention. The optical disc recording/reproducing apparatus of FIG. 1 has a spindle motor 1, a feeding motor 17, a pickup head 2 (PUH), an error signal generator 3, a servo processing unit 4, a gain amplifier 5, an RF signal generator 6, an RF binarizing unit 7, a PLL controller 8, a data demodulation unit 9, an LPP signal generator 10, an LPP detector 11, an LPP decoder 12, a wobble signal generator 13, a wobble PLL controller 14, a recording clock generator 15 and a controller 16.

The pickup head 2 has a plurality of laser light sources not shown and a plurality of light intensity detectors not shown corresponding to the laser light sources. One of the laser light sources is a main laser light source, and the corresponding light intensity detector is called as a main light intensity detector. The other laser light sources are sub-laser light sources, and the corresponding light intensity detectors are called as sub-light intensity detectors.

The gain amplifier 5 amplifies the detecting signal of the main light intensity detector corresponding to the reflected signal of the laser detected by the pickup head 2 and the detecting signals of the sub-light intensity detectors.

The error signal generator 3 generates error signals such as a focus error signal and a tracking error signal based on the main light intensity detecting signal and the sub-light intensity detecting signals amplified by the gain amplifier 5. The servo processing unit 4 controls a lens position in the pickup head 2 based on positioning information obtained by the focus error signal and the tracking error signal, rotation of the spindle motor 1 for setting the optical disc to a desirable rotation speed, and a drive of the feeding motor 17 in a radial direction of the disc for moving the pickup head 2 to a desirable disc position.

The RF signal generator 6 generates the RF signal based on the detecting signal of the main light intensity detector. The RF binarizing unit 7 binarizes the RF signal. The PLL controller 8 generates a reproducing clock based on data binarized by the RF binarizing unit 7. The data demodulation unit 9 demodulates data binarized by the RF binarizing unit 7 in sync with the reproducing clock.

The LPP signal generator 10 generates the pre-pit signal (LPP signal) based on a push-pull signal generated by the detecting signal of the main light intensity detector. Here, the push-pull signal is a signal obtained by adding the detecting signals of half faces, respectively, in terms of a normal direction of the tracks of the optical disc, i.e. adding the detecting signals at inner circumference side and the detecting signals at outer circumference side, and subtracting them.

The LPP detector 11 generates the LPP detecting signal by binarizing only the spike portions of the LPP signal. The LPP decoder 12 decodes the LPP detecting signal to convert the LPP detecting signal into the pre-pit information.

The wobble signal generator 13 generates the wobble signal based on the push-pull signal generated by the main light intensity detecting signal. The wobble signal is recoded to the grooves in advance in a form of winding in a radial direction-with a frequency based on a channel clock. The wobble signal is used for extracting a control clock used for rotation control of the disc and the disc recording. The control clock has a cycle of integral multiple of the channel clock.

The wobble PLL controller 14 generates a clock capable of synchronizing with a phase of the wobble signal generated by the wobble signal generator 13. Extraction of the control clock for rotation control and recording of the disc is conducted based on the clock capable of synchronizing with the phase.

The recording clock generator 15 generates the recording clock by changing the cycle of the clock generated by the wobble PLL controller 14 to integral multiplication in accordance with rotation speed.

The above-described units perform the respective processings based on the control of the controller 16.

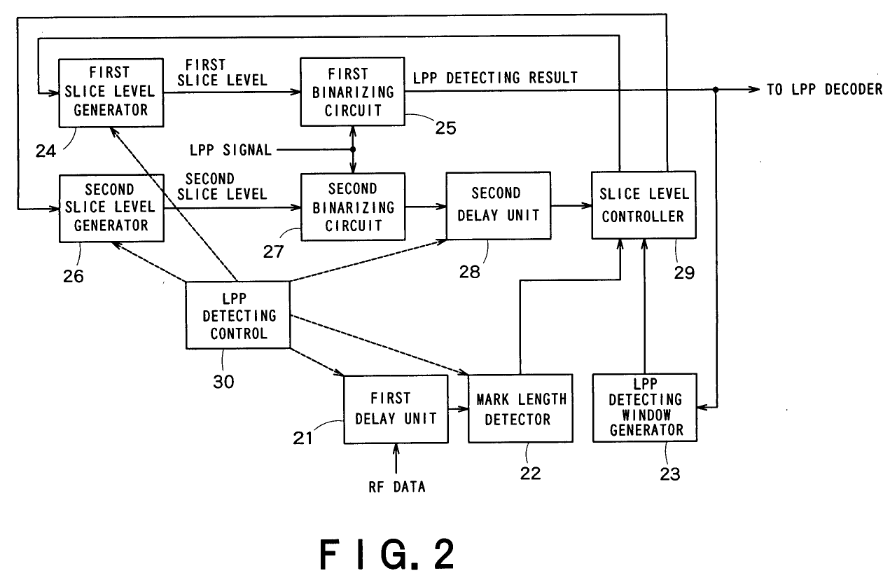

The LPP detector 11 as a characteristic portion of the embodiment performs the LPP detection continuously during recording/reproducing of the optical disc. FIG. 2 is a block diagram showing an example of internal configuration of the LPP detector 11. The LPP detector 11 in FIG. 2 has a first delay unit 21, a mark length detector 22, an LPP detecting window generator 23, a first slice level generator 24, a first binarizing circuit 25, a second slice level generator 26, a second binarizing circuit 27, a second delay unit 28, a slice level controller 29 and an LPP detecting controller 30.

The first delay unit 21 and the second delay unit 28 are provided to conform the phase of the RF signal generated by the RF signal generator 6 to the phase of the LPP signal generated by the LPP signal generator 10. More specifically, the first delay unit 21 and the second delay unit 28 amend differences of signal transmission times in the case of passing through the RF signal generator 6 and the LPP signal generator 10.

The mark length detector 22 detects the marks having a specific mark length, i.e. one of 3-11T and 14T, where T=1/26.16MHz at DVD standard speed.

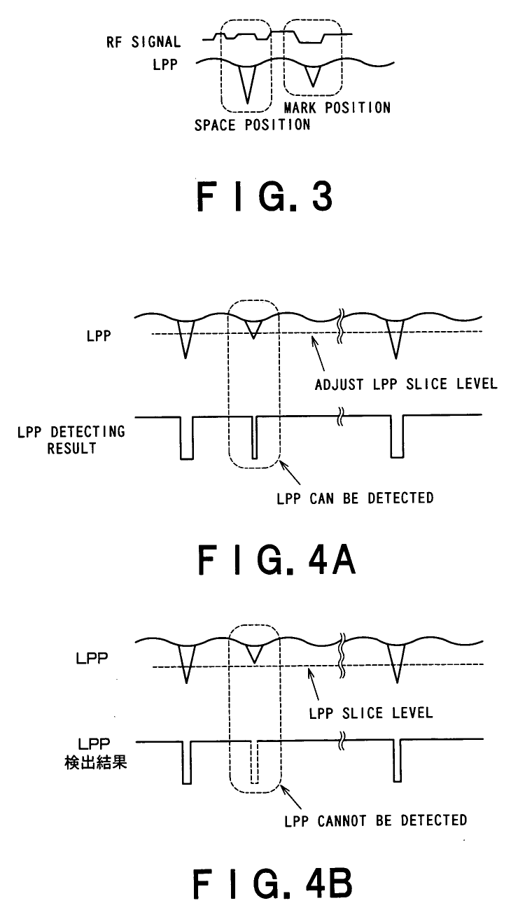

FIG. 3 is a diagram showing one example of a waveform of the spike portion of the LPP signal. As shown in FIG. 3, as the mark length is long, the amplitude of the RF signal becomes large, and therefore the spike portion of the LPP signal becomes small, and it becomes impossible to detect the LPP signal. Because of this, the mark length detector 22 detects a specific mark having longer mark length so as to be able to surely detect the spike portion corresponding to the mark having the long mark length.

The first slice level generator 24 generates a first slice level as a reference for detecting the spike portion of the LPP signal. The first binarizing circuit 25 binarizes the LPP signal based on whether or not the LPP signal exceeds the first slice level.

The LPP detecting window generator 23 generates the LPP detecting window indicating a period (timing) for the LPP detection based on the LPP detecting signal binarized by the first binarizing circuit 25. More specifically, the LPP detecting window generator 23 sets the LPP detecting window to areas assumed that the spike portion of the LPP signal exists.

The second slice level generator 26 generates the second slice level for detection. The second slice level can be changed arbitrarily. The second binarizing circuit 27 binarizes the LPP signal by whether or not the LPP signal exceeds the second slice level.

The slice level controller 29 detects a detecting probability of the spike portion included in the LPP signal based on a specific mark detected by the mark length detector 22, the LPP detecting window generated by the LPP detecting window generator 23, and the LPP detecting signal binarized by the second binarizing circuit 27.

FIG. 4A is the LPP detecting signal in the case where the slice level is high, and FIG. 4B is the LPP detecting signal in the case where the slice level is low. As shown in these diagrams, when the slice level is high, it is possible to detect the small spike portion in the LPP signal. However, when the slice level becomes low, it is impossible to detect the small spike portion in the LPP signal.

The slice level controller 29 sets a period that the LPP detecting window set by the LPP detecting window generator 23 and the specific mark length detecting signal detected by the mark length detector 22 overlap with each other as the specific LPP detecting window based on the LPP detecting window and the specific mark length detecting signal. The spike portion of the LPP signal is detected in the specific LPP detecting window.

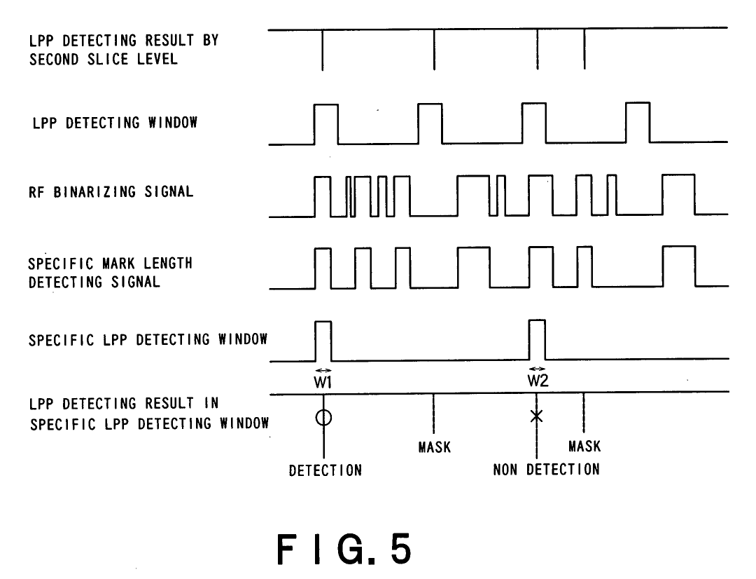

FIG. 5 is a diagram showing one example of the processing result of the slice level controller 29. As shown in FIG. 5, the specific LPP detecting window is generated in a period that the LPP detecting window and the specific mark length detecting signal overlap with each other. FIG. 5 shows an example in which two specific LPP detecting windows w1, w2 are provided. The spike portion is detected in w1, but the spike portion is not detected in w2.

As shown in FIG. 5, the mark length detector 22 outputs the mark with the mark length longer than a predetermined length among the marks (high level) included in the RF signal binarized by the RF binarizing unit 7 (RF binarizing signal). The slice level controller 29 generates the specific LPP detecting window in a period that the LPP detecting window and the specific mark length detecting signal are high level.

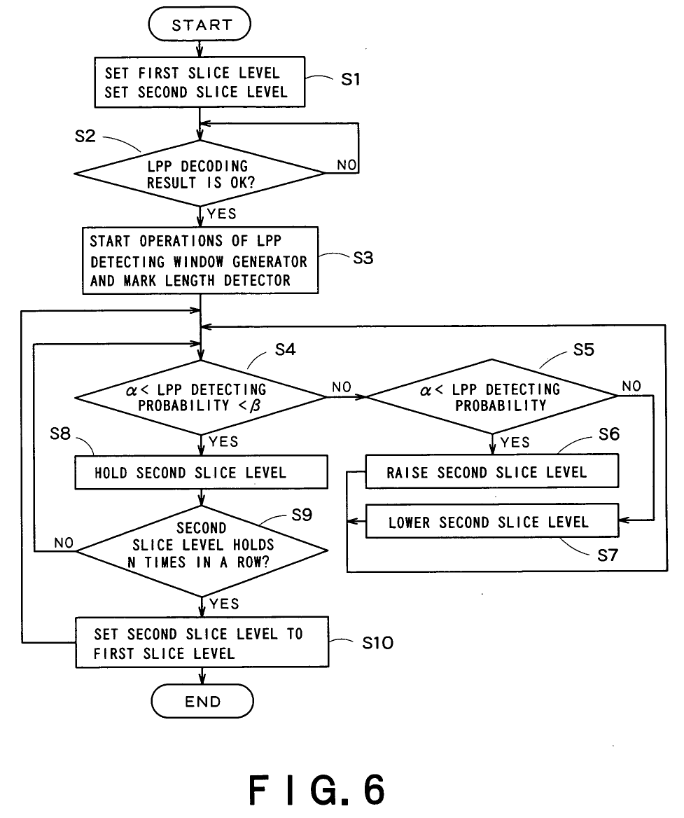

FIG. 6 is a flowchart showing one example of processing operations of the slice level controller 29. First, the first slice level and the second slice level are set initially (step S1). Similarly, coefficients α, β for determining the detecting probability, a specific mark length to be detected and a coefficient N indicating an update timing of the first slice level are set initially.

Hereinafter, an optimal value of the slice level is “100”, an initial value of the first slice level is “30” and an initial value of the second slice level is “50”. The specific mark length is 10T or more, and the coefficients are α=0.9, β=1.1 and N=5. “N=5” indicates that the cases where the detecting probability of the LPP signal becomes a value from α to βhave occurred five times in a row.

After the operations have been started, in a state that the first slice level is set to “30”, when the LPP decoder 12 has performed correct decoding process of the LPP signal (step S2), the LPP detecting window generator 23 and the mark length detector 22 begin the operations, and the specific LPP detecting window is generated to detect the LPP signal adjacent to the mark having the mark length of 10T or more. (step S3).

Next, the LPP detecting probability is calculated by setting the number of the specified detecting windows during a certain period as a denominator, and setting the number of the spike portions of the LPP signals detected by using the second slice level during the period as a nominator. It is determined whether the LPP detecting probability is larger than the coefficient α and smaller than the coefficient β (step S4).

For example, if assumed that the number of the specific LPP detecting window during a certain period is “100”, the second slice level is “50” and the LPP detecting counts in a certain period is “50”, the LPP detecting probability is 50/100=0.5. Since the LPP detecting probability at this case is smaller than α=0.9, the determination in step S4 is “No”. Therefore, the processing in step S5 is performed, and it is determined whether the LPP detecting probability is a or less (step S5).

In the above-described example, the determination in step S5 is “Yes”. Therefore, the processing for raising the second slice level is performed (step S6). Here, the processing for raising the second slice level by “10” is performed. Afterwards, the processing in step S4 is again performed. On the other hand, if the determination in step S5 is “No”, it indicates that the LPP detecting probability is larger than β. In this case, the processing for lowering the second slice level is performed (step S7). Afterwards, the processing in step S4 is performed.

The same processings are repeatedly performed. When the second slice level has become “90” and the LPP detecting probability has become “0.95”, the determination in step S4 becomes “Yes”, and the second slice level is held (step S8).

When the processing in step S8 ends, it is determined whether the second slice level is held continuously N times (step S9). If “No”, the processing in step S4 is performed. If “Yes”, the second slice level is set to the first slice level (step S10). Therefore, a final slice level is set, and the LPP detecting signal detected by using the first slice level is sent to the LPP decoder 12.

The result shown in FIG. 4A is obtained by performing the processing in FIG. 6. As shown in FIG. 4A, even if the small spike portion is included in the LPP signal, it is possible to surely detect the small spike portion by adjusting the second slice level so that the spike portion can be surely detected.

In this way, according to the first embodiment, the specific LPP detecting window for detecting the specific mark is set, the second slice level is adjusted in the specific LPP detecting window to detect an optimum slice level, and by setting the result as the first slice level, the LPP signal is detected. Therefore, it is possible to surely detect the LPP signal even in the small spike portion adjacent to the mark, thereby improving the reproducing accuracy of the optical disc.

(Second embodiment)

A second embodiment is different from the first embodiment in how to generate the LPP detecting window.

A physical sector of DVD is composed of 26 pieces of sync frames (one sync frame corresponds to 1488 channel bits). A sync pattern is arranged at a head of each frame. Long data of 14T exists in the sync pattern. On the other hand, the LPP signal arranged at the land track is composed of three bits units per the sync frame. The head bit is arranged so as to neighbor to the sync pattern of the recording data.

In the present embodiment, the specific LPP detecting window is predicted and generated in conformity with a position of long data included in the sync pattern detected by the data demodulator 9. The long data corresponds to a specific mark. The LPP signal is usually arranged adjacent to the sync pattern of an even frame. Therefore, the LPP detecting window generator 23 according to the present embodiment generates the LPP detecting window in the even frame in conformity with the LPP position.

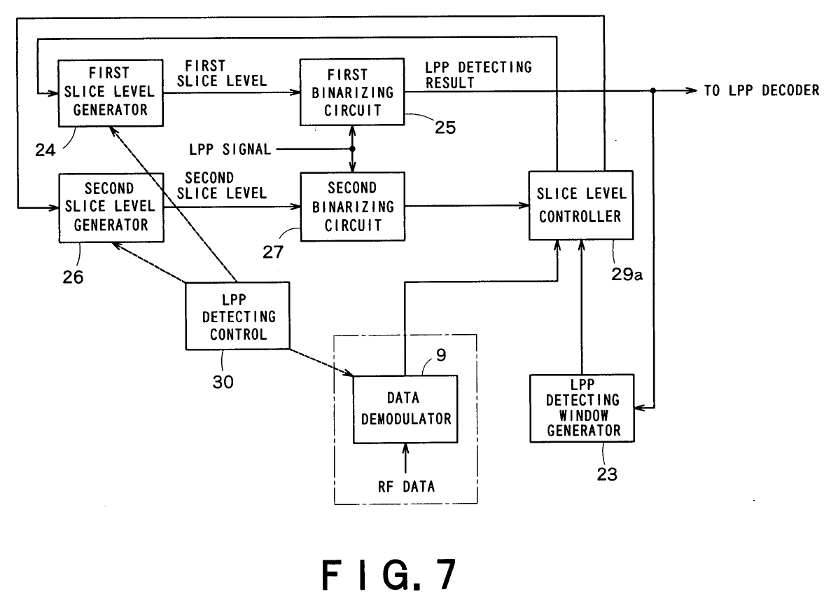

FIG. 7 is a block diagram showing internal configuration of the LPP detector 11 according to the second embodiment. In FIG. 7, the same reference numerals are attached to constituents common to FIG. 2. Hereinafter, different points will be mainly described.

The LPP detector 11 in FIG. 7 has configurations omitting the first delay unit 21 and the mark length detector 22 in FIG. 2. Data obtained by demodulating the RF signal by the data demodulator 9 in FIG. 1 is inputted in the slice level controller 29a.

The slice level controller 29a detects the sync pattern from the reproducing data obtained by demodulating by the data demodulator 9, to predict and generate the specific LPP detecting window in conformity with a long data position in the sync pattern.

The second embodiment is similar to the first embodiment except that a method of generating the specific LPP detecting window is different from that of the first embodiment. The slice level controller 29 detects the pre-pit signal by performing the processings in FIG. 6 by using the specific LPP detecting window.

In this way, according to the second embodiment, the specific LPP detecting window is generated in conformity with the long data position included in the sync pattern. Therefore, it is possible to simplify internal configuration of the LPP detector 11, compared with the first embodiment, thereby downsizing the circuit volume and reducing power consumption.

(Third embodiment)

In the first and second embodiments, a circuit path for binarizing data by using the first slice level and a circuit path for binarizing data by using the second slice level have been used. On the other hand, a third embodiment integrates these two circuit paths into one.

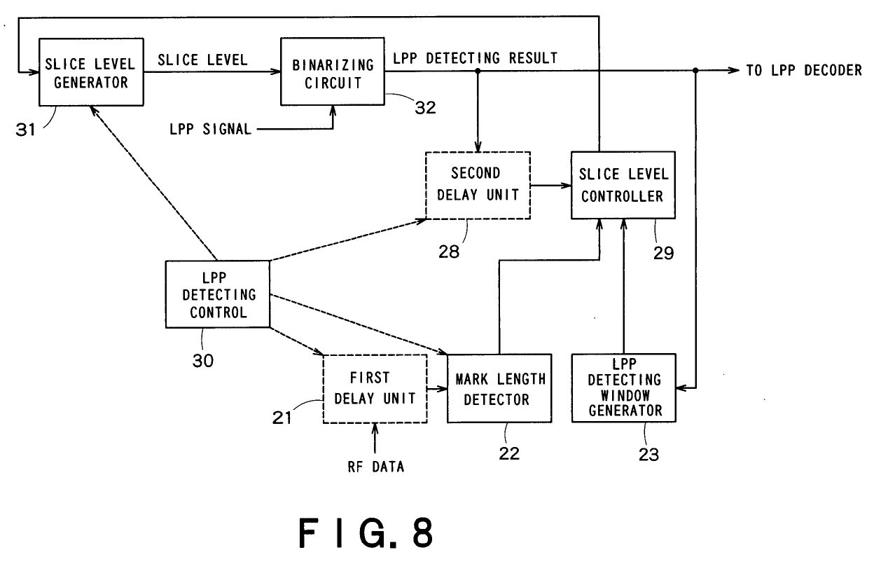

FIG. 8 is a block diagram showing internal configuration of the LPP detector 11 according to a third embodiment. In FIG. 8, the same reference numerals are attached to the constituents common to those of FIG. 2. Hereinafter, different points will be mainly described.

The LPP detector 11 in FIG. 8 has the slice level generator 31 and the binarizing circuit 32 by each one, compared with the LPP detector 11 in FIG. 2. The LPP detecting signal binarized by the binarizing circuit 32 is not only sent to the LPP decoder 12, but also the second delay unit 28.

The slice level generator 31 serves as the first and second slice level generators 24, 26. As initial setting, the slice level similar to the first slice level generated by the first slice level generator 24 in FIG. 2 is generated. Afterwards, the slice level is changed in the same way as the second slice level generator 26 in FIG. 2, and the LPP detecting probability indicating the number of the spike portions in the specific LPP detecting window for the number of the LPP detecting window in a certain period is calculated. Afterwards, the slice level satisfying α<LPP detecting probability <β is set as the final slice level to detect the LPP signal.

In this way, according to the third embodiment, different from the first and second embodiments, it is possible to detect an optimum slice level only with one type of slice level, thereby largely simplifying internal configuration of the LPP detector 11.

In FIG. 8, the first and second delay units 21 and 28 are shown in dotted lines. These delay units may be consolidated into one, or connection points may be changed. The first and second delay units in FIG. 2 are the same.

Although the delay unit is omitted in FIG. 7, the delay unit may be needed to adjust difference between the delay required to detect the sync pattern based on the result of demodulating the binarized RF data and the delay required for the LPP detection. These delay units are omitted in FIG. 7 for simplification.

What is claimed is:

1. A pre-pit signal detector, comprising:
a first binarizing unit which converts RF data obtained by reading out information recorded by irradiating a laser light on an optical disc into first binary data composed of a mark and a space;
a specific mark detector which detects a specific mark included in the first binary data;
an LPP detecting window generator which generates an LPP detecting window indicating a range of detecting a pre-pit signal arranged adjacent to the specific mark;
a second binarizing unit which generates second binary data by whether or not a signal obtained by reading out the pre-pit signal with the laser light excesses a predetermined slice level; and
a slice level adjusting unit which adjusts the slice level based on a result detected by the specific mark detector, the LPP detecting window and the second binary data.

2. The pre-pit signal detector according to claim 1,
wherein the second binarizing unit includes:
a reference binarizing unit which generates the second binary data by whether the signal obtained by reading out the pre-pit signal with the laser light excesses a first slice level; and
a supplementary binarizing unit which generates a third binary data by whether the signal obtained by reading out the pre-pit signal with the laser light excesses a second slice level adjusted by the slice level adjusting unit,
wherein the slice level adjusting unit adjusts the slice level based on a detecting probability of the pre-pit signal detected by the third binary data.

3. The pre-pit signal detector according to claim 2,
wherein the slice level adjusting unit includes:
a determination unit which determines whether or not the detecting probability of the pre-pit signal detected by the third binary data is a value within a predetermined range a predetermined times in a row; and
a slice level changing unit which sets the second slice level to the first slice level when a result determined by the determination unit is affirmative.

4. The pre-pit signal detector according to claim 3,
wherein the slice level adjusting unit changes the second slice level when a result determined by the determination unit is negative.

5. The pre-pit signal detector according to claim 3,
wherein the slice level adjusting unit generates a specific LPP detecting window indicating a range narrower than the LPP detecting window for detecting the pre-pit signal based on a result detected by the specific mark detector and the LPP detecting window; and
the determination unit and the slice level changing unit perform the respective processings only in the specific LPP detecting window.

6. The pre-pit signal detector according to claim 5,
wherein the slice level adjusting unit generates the specific LPP detecting window within a period that the signal indicating the result detected by the specific mark detector and the LPP detecting window overlap in time.

7. The pre-pit signal detector according to claim 1,
wherein the specific mark is a mark with a predetermined length or more among a plurality of types of marks with lengths different from each other recorded in the optical disc.

8. The pre-pit signal detector according to claim 1,
a pre-pit signal generator which generates the pre-pit signal;
a first delay unit which performs time adjustment of the first binary data; and
a second delay unit which performs time adjustment of the second binary data,
wherein the specific mark detector detects the specific mark included in a first binary data adjusted with time by the first delay unit; and
the slice level adjusting unit adjusts the slice level based on the second binary data adjusted with time by second delay unit.

9. The pre-pit signal detector according to claim 1, further comprising:
a sync detector which detects a sync pattern provided for each frame from the first binary data,
wherein the specific mark is a mark with a predetermined length included in the sync pattern.

10. The pre-pit signal detector according to claim 9,
wherein the LPP detecting window generator generates the LPP detecting window in conformity with a position of the sync pattern of an even frame.

11. An optical disc recording/reproducing apparatus, comprising:
an optical pickup which reads out information recorded to an optical disc by irradiating a laser light;
an RF data generator which generates RF data based on an output signal of the optical pickup;
a first binarizing unit which converts the RF data into first binary data composed of a mark and a space;
a pre-pit detector which detects a pre-pit signal based on the first binary data,
wherein the pre-pit detector includes:
a specific mark detector which detects a specific mark included in the first binary data;
an LPP detecting window generator which generates an LPP detecting window indicating a range of detecting a pre-pit signal arranged adjacent to the specific mark;
a second binarizing unit which generates second binary data by whether or not a signal obtained by reading out the pre-pit signal with the laser light excesses a predetermined slice level; and
a slice level adjusting unit which adjusts the slice level based on a result of detecting the specific mark detector, the LPP detecting window and the second binary data.

12. The optical disc recording/reproducing apparatus according to claim 11,
wherein the second binarizing unit includes:
a reference binarizing unit which generates the second binary data by whether the signal obtained by reading out the pre-pit signal with the laser light excesses a first slice level; and
a supplementary binarizing unit which generates a third binary data by whether the signal obtained by reading out the pre-pit signal with the laser light excesses a second slice level adjusted by the slice level adjusting unit,
wherein the slice level adjusting unit adjusts the slice level based on a detecting probability of the pre-pit signal detected by the third binary data.

13. The optical disc recording/reproducing apparatus according to claim 12,
wherein the slice level adjusting unit includes:
a determination unit which determines whether or not the detecting probability of the pre-pit signal detected by the third binary data is a value within a predetermined range a predetermined times in a row; and
a slice level changing unit which sets the second slice level to the first slice level when a result determined by the determination unit is affirmative.

14. The optical disc recording/reproducing apparatus according to claim 13,
wherein the slice level adjusting unit changes the second slice level when a result determined by the determination unit is negative.

15. The optical disc recording/reproducing apparatus according to claim 13,
wherein the slice level adjusting unit generates a specific LPP detecting window indicating a range narrower than the LPP detecting window for detecting the pre-pit signal based on a result detected by the specific mark detector and the LPP detecting window; and
the determination unit and the slice level changing unit perform the respective processings only in the specific LPP detecting window.

16. The optical disc recording/reproducing apparatus according to claim 15,
wherein the slice level adjusting unit generates the specific LPP detecting window within a period that the signal indicating the result detected by the specific mark detector and the LPP detecting window overlap in time.

17. The optical disc recording/reproducing apparatus according to claim 11,
wherein the specific mark is a mark with a predetermined length or more among a plurality of types of marks with lengths different from each other recorded in the optical disc.

18. The optical disc recording/reproducing apparatus according to claim 11,
a pre-pit signal generator which generates the pre-pit signal;
a first delay unit which performs time adjustment of the first binary data; and
a second delay unit which performs time adjustment of the second binary data,
wherein the specific mark detector detects the specific mark included in a first binary data adjusted with time by the first delay unit; and
the slice level adjusting unit adjusts the slice level based on the second binary data adjusted with time by second delay unit.

19. The optical disc recording/reproducing apparatus according to claim 11, further comprising:
a sync detector which detects a sync pattern provided for each frame from the first binary data,
wherein the specific mark is a mark with a predetermined length included in the sync pattern.

20. The optical disc recording/reproducing apparatus according to claim 19,
wherein the LPP detecting window generator generates the LPP detecting window in conformity with a position of the sync pattern of an even frame.
